(19) United States
(12) Patent Application Publication
(10) Pub. No.: US 2020/0273203 A1
(43) Pub. Date: Aug. 27, 2020

(54) CALCULATION METHOD, ARTICLE MANUFACTURING METHOD, RECORDING MEDIUM, INFORMATION PROCESSING APPARATUS, AND SYSTEM

(71) Applicant: CANON KABUSHIKI KAISHA, Tokyo (JP)

(72) Inventor: Hideaki Kitamura, Utsunomiya-shi (JP)

(21) Appl. No.: 16/788,751

(22) Filed: Feb. 12, 2020

(30) Foreign Application Priority Data
Feb. 27, 2019 (JP) 2019-034286
Sep. 24, 2019 (JP) 2019-173518

(51) Int. Cl. G06T 7/73; G06T 7/579; G06T 7/521; G06T 7/246

(52) U.S. Cl. CPC G06T 7/74; G06T 7/248; G06T 7/521; G06T 7/579

(57) ABSTRACT

A method for calculating a position of an object includes a first process to calculate a first position measurement value of a reference member in a depth direction of a measurement range of a three-dimensional measurement apparatus using a measurement result of the reference member measured by the three-dimensional measurement apparatus and a second process to calculate a second position measurement value of the reference member and a position of the object in the depth direction using measurement results of the reference member and the object measured by the three-dimensional measurement apparatus. In the second process, the position of the object is calculated by correcting an error difference which varies according to the position of the object in the depth direction, using the first position measurement value and the second position measurement value of the reference member.

### BACKGROUND

### Field of the Disclosure

The present disclosure relates to a calculation method, a manufacturing method of an article, a recording medium, an information processing apparatus, and a system.

### Description of the Related Art

Three-dimensional position measuring techniques have been used in various purposes. In the three-dimensional position measuring, an image of a measurement target object is captured and a three-dimensional position of the target object is measured from the captured target object image. In recent years, robots have been working in some operations in industrial products production processes which are conventionally performed by persons. For example, in a picking process in which a robot grips a workpiece from workpieces piled up on a tray and moves the workpiece to a specified place, a three-dimensional position measuring technique which can stably and highly accurately measure a position and a posture of the workpiece is used.

Examples of the three-dimensional position measuring techniques include a pattern projection method which is based on the principle of triangulation. In the pattern projection method, a shape and a position of a target object is measured by illuminating the target object with light and dark pattern light generated by a pattern generation unit using a projector and capturing the pattern light curved along a shape of the target object as an object to be inspected from an angle different from an illumination direction by an image capturing unit.

Since optical systems of the image capturing unit and the projector expand and contract with temperature, a relative position and posture of the optical systems varies. The variation may sometimes result in deviation in a measurement result of a point on the target object in some cases.

Particularly in a projection system, an object temperature and temperature distribution in the vicinity are changed readily by heat generated in a light source. In an example case of a pattern generation unit including a reflection type display element, since an optical system of the pattern generation unit includes a reflective surface, the optical system is sensitive to deformation due to temperature and the like.

Therefore, a temperature change is corrected. However, a deviation in a measurement result may not uniformly change in an environment in which temperature changes largely. In such a case, highly accurate temperature correction becomes difficult, and a correction residual error also becomes an issue.

In view of the issue, Japanese Patent Applications Laid-Open No. 2008-170279 and No. 2013-231900 discusses a method in which calibration measurement is performed on a three-dimensional position measurement apparatus using a reference object having a known shape and pattern and a position and a posture measured by the three-dimensional position measurement apparatus are calibrated.

According to the method discussed in Japanese Patent Applications Laid-Open No. 2008-170279 and No. 2013-231900, many pieces of position information about known patterns and shapes are used for calibration targets as reference objects for calibration, and the three-dimensional position measurement apparatus tends to be upsized. Therefore, in calibration of three-dimensional position measurement apparatuses in production processes of industrial products, measurement target objects are moved away after an interruption or completion of a measurement operation to set a calibration reference object for calibration, which may reduce production efficiency.

Meanwhile, there is a method for correcting a measurement error of a measurement target object uniformly regardless of a position in a measurement range. With the method, a three-dimensional position measurement apparatus obtains a variation of measurement results of a simple reference object and corrects a measurement error using the variation as a correction value.

However, three-dimensional position measurement apparatuses may obtain different deviation amounts between measurement results due to a temperature change, and if a measurement error is uniformly corrected, a correction residual error may occur in some positions in the measurement range. Consequently, in such a position, a robot cannot grip a target object even in the measurement range of the three-dimensional position measurement apparatus in a picking process of the production processes, which may interrupt the production processes.

### SUMMARY

According to an aspect of the present invention, a method for calculating a position of an object includes calculating, as a first process, a first position measurement value of a reference member in a depth direction of a measurement range of a three-dimensional measurement apparatus using a measurement result of the reference member measured by the three-dimensional measurement apparatus and calculating, as a second process, a second position measurement value of the reference member and a position of the object in the depth direction using measurement results of the reference member and the object measured by the three-dimensional measurement apparatus, wherein, in the second process, the position of the object is calculated by correcting an error difference which varies according to the position of the object in the depth direction, using the first position measurement value and the second position measurement value of the reference member.

Further features of the present invention will become apparent from the following description of exemplary embodiments with reference to the attached drawings.

### BRIEF DESCRIPTION OF THE DRAWINGS

FIG. 1 is a diagram illustrating a configuration example of a three-dimensional position measurement apparatus.

FIG. 2 is a diagram illustrating a definition of coordinates.

FIG. 3 is a flowchart according to a first example.

FIG. 4 is a diagram illustrating Z direction correction according to the first example.

FIG. 5 is a diagram illustrating XY direction correction according to the first example.

FIG. 6 is a diagram illustrating the XY direction correction according to the first example.

FIG. 7 is a flowchart according to a second example.

FIG. 8 is a diagram illustrating Z direction correction according to the second example.

FIG. 9 is a flowchart according to a third example.

FIG. 10 is a diagram illustrating Z direction correction according to the third example.

FIG. 11 is a flowchart according to a fourth example.

FIG. 12 is a diagram illustrating correction according to a second exemplary embodiment.

FIG. 13 is a diagram illustrating a system.

### DESCRIPTION OF THE EMBODIMENTS

The present invention is described in detail below with reference to the attached drawings. The same members are denoted by the same reference numerals in each drawing.

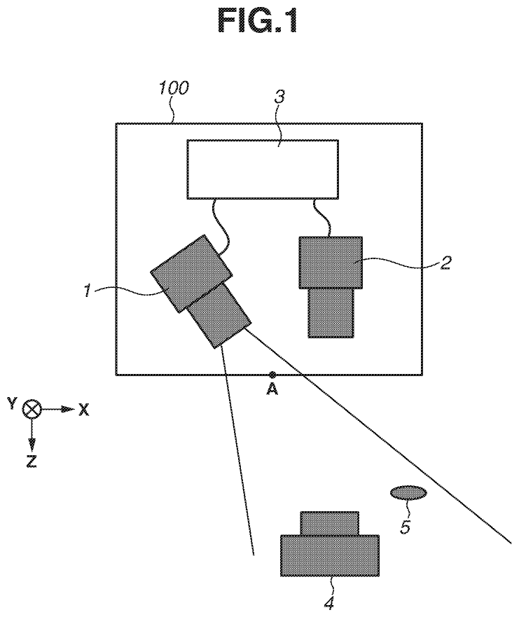

FIG. 1 is a diagram illustrating a configuration of a three-dimensional position measurement apparatus (a three-dimensional measurement apparatus) 100 according to a first exemplary embodiment. The three-dimensional position measurement apparatus 100 includes a projector 1, an image capturing unit 2 (a three-dimensional measurement unit), and an arithmetic processing unit 3. The projector 1 includes a light-emitting diode (LED) light source for measurement, a pattern generation unit including a liquid crystal panel for generating pattern light, and a projection lens (a projection optical system) for projecting the generated pattern light.

The light source and the pattern generation unit can be electrically controlled by the arithmetic processing unit (an information processing apparatus) 3, such as a processor, and generate pattern light having stripes only in a light part or of a light and dark part to illuminate an inspection target object (a workpiece) 4 as a measurement target object and a reference mark 5 as a reference member with the generated light. The pattern generation unit may use a digital mirror device (DMD) and a mask having a light shielding pattern instead of the liquid crystal panel.

The reference mark 5 is disposed within a range in which the three-dimensional position measurement apparatus 100 can perform measurement. Alternatively, the reference mark 5 can be fixed at a position out of a measurement guarantee range of the inspection target object 4 and not interfering with the inspection target object 4 or mounted on a robot and arranged at a predetermined position by moving the robot.

The image capturing unit 2 includes a lens (an optical system) for receiving light from a measurement target object on which a pattern is projected and an image pickup element such as a charge coupled device (CCD), and an optical axis of the optical system is arranged with an angle different from an optical axis of the projector 1 (a projection lens). The image capturing unit 2 captures the pattern light curved along shapes of the inspection target object 4 and the reference mark 5 as a two-dimensional image. The image capturing unit 2 captures images of the inspection target object 4 and the reference mark 5 (a disposed object) for a plurality of times by changing the pattern light to be projected, and thus a plurality of images is obtained. The arithmetic processing unit 3 calculates positions (distance information) of a plurality of measurement points of the object using the plurality of captured image (measured data) based on the principle of triangulation. Coordinates as position (distance) measurement results of the inspection target object 4 and the reference mark 5 from the three-dimensional position measurement apparatus 100 can be obtained from the position measurement results by the three-dimensional position measurement apparatus 100.

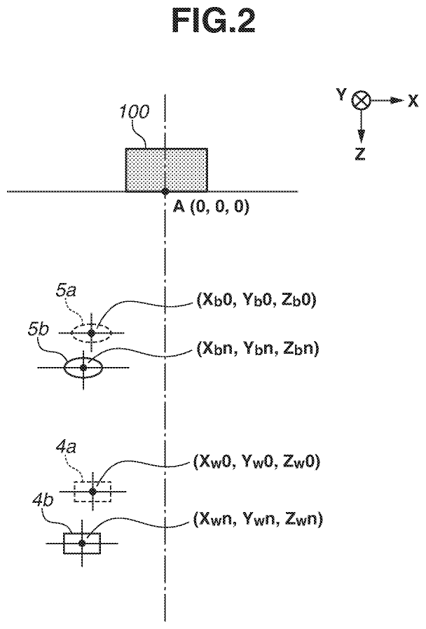

Immediately after calibration in a state in which the inspection target object 4 is not included, the inspection target object 4 and the reference mark 5 can be measured with less error with respect to actual positions. FIG. 2 illustrates a measurement result 5a of a reference mark in this state, and coordinates (X_{b}0, Y_{b}0, Z_{b}0) in this state is referred to as mark reference coordinates. A measurement result 4a (a state close to a true position) of the inspection target object 4 is the one to be expected in a case where measurement is performed in this state, and coordinates (X_{w}0, Y_{w}0, Z_{w}0) in this state is referred to as workpiece reference coordinates.

With a center A of a vertex on an exterior of the three-dimensional position measurement apparatus 100 as an origin, a Z-axis direction is a depth direction in the measurement range viewed from the three-dimensional position measurement apparatus 100. An X axis is an axis which is perpendicular to the Z axis and exists on a plane including a direction of base lengths of the projection optical system of the three-dimensional position measurement apparatus 100 and the optical system of the image capturing unit, and a Y axis is an axis perpendicular (in a perpendicular direction) to the X axis and the Z axis.

In a case where a temperature change occurs in the three-dimensional position measurement apparatus 100, since the optical systems of the image capturing unit 2 and the projector 1 expand or contract in response to changes in a usage environment such as temperature, a relative position and posture of the optical systems of the image capturing unit 2 and the projector 1 varies. The variation may cause a deviation in a measurement result of the inspection target object 4. Therefore, for example, in a case where the temperature of the three-dimensional position measurement apparatus 100 changes after calibration, measurement results of the inspection target object 4 and the reference mark 5 by the three-dimensional position measurement apparatus 100 after the temperature change include errors which are measurement deviations. FIG. 2 illustrates a measurement result 4b of the inspection target object 4 and a measurement result 5b of the reference mark 5 in a state after the temperature change. Coordinates of the measurement result 4b and coordinates of the measurement result 5b are expressed as workpiece coordinates (X_{w}n, Y_{w}n, Z_{w}n) and mark coordinates (X_{b}n, Y_{b}n, Z_{b}n), respectively.

While FIG. 2 illustrates a case in which a single reference mark 5 is measured, the number of the reference marks may be two or more without being limited to one. However, calibration can be performed in a simple configuration by arranging a small number of reference marks in a part of the measurement range and performing calibration instead of arranging many reference marks to cover the entire measurement range of the three-dimensional position measurement apparatus 100.

A measurement error in the Z-axis direction due to a posture change in a main component of the three-dimensional position measurement apparatus 100 has a characteristic with which the measurement error varies by approximately a power of 2 with respect to a ratio of a distance in the Z-axis direction from the three-dimensional position measurement apparatus 100. This is because many variations in shifts (deviations) in positions of the main components, such as the lens and the pattern generation unit of the projector 1 and the image pickup element of the image capturing unit 2 in the three-dimensional position measurement apparatus 100 and in a convergence angle between the projector 1 and the image capturing unit 2, serve as components corresponding to changes in inclinations of the optical axes. Therefore, a relationship between a position in the Z-axis direction and an error due to the temperature change and the like is expressed by the following Equation 1:

(Z_{b}n−Z_{b}0):(Z_{w}n−Z_{w}0)=Z_{b}n\hat{ }2:Z_{w}n\hat{ }2 (Equation 1).

In other words, an error of the workpiece coordinate Z_{w}n included in a position measurement result of the inspection target object 4 can be calculated by the following procedures. First, the mark reference coordinate Z_{b}0 is obtained in advance in a state in which a relative position of coordinates of the object to be inspected and the reference object can be correctly measured. Next, the reference mark 5 is measured when the inspection target object 4 is measured, and the error of the workpiece coordinate Z_{w}n of the measurement point in the inspection target object 4 can be calculated by Equation 1 based on the obtained workpiece coordinate Z_{w}n and the obtained mark coordinate Z_{b}n.

While, in the above described case, correction is performed based on the measured result of the inspection target object 4, an amount varied from the mark coordinates 5b and the mark reference coordinates 5a may be replaced with a variation in an apparatus parameter (for example, a convergence angle). By correcting coordinates of an entire measurement space, the measurement result of the inspection target object 4 may be calculated.

An error is calculated using a distance in the Z-axis direction from the origin A of the three-dimensional position measurement apparatus 100. However, since the distance between the three-dimensional position measurement apparatus 100 and the inspection target object 4 or the reference mark 5 in the Z-axis direction is large enough, an error may be calculated using a distance from a certain point near the three-dimensional position measurement apparatus 100 if there is no significant difference.

Next, each example is described.

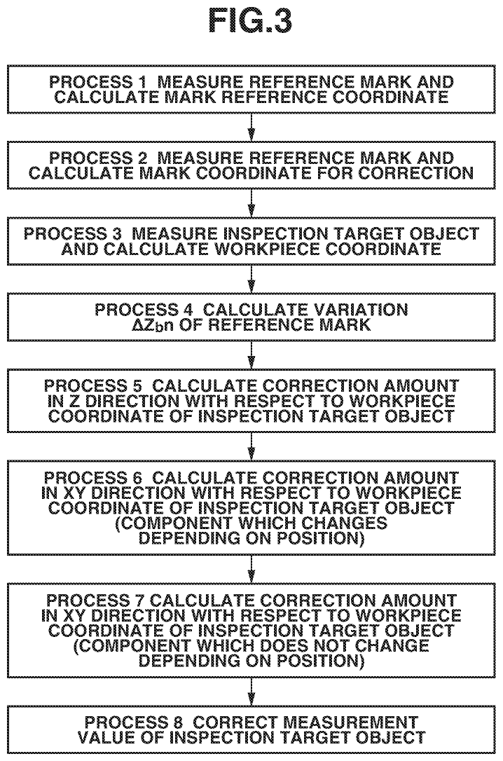

FIG. 3 is a flowchart illustrating a measurement method (a calculation method) according to a first example. Each procedure is performed by the projector 1, the image capturing unit 2, and the arithmetic processing unit 3 of the three-dimensional position measurement apparatus 100. However, arithmetic processing may be performed using an external computer (an information processing apparatus). The arithmetic method can be realized by, for example, supplying a program for executing each procedure in the flowchart to a computer as an information processing apparatus via a network or a storage medium and reading and executing the program by the information processing apparatus. The arithmetic method can be also realized by the information processing apparatus reading a program stored in a storage medium such as a memory and executing the program.

First, in Process 1 (a first process), the reference mark 5 is measured in a state in which a relative position between the inspection target object 4 and the reference mark 5 is correctly measured, for example, after calibration, and the mark reference coordinates (a first position measurement value) 5a are calculated as coordinate information of a correction reference. Process 1 is executed in a case where an actual position of the reference mark 5 is shifted, the position is shifted with respect to the mark reference coordinates obtained when Process 1 is executed in the past, and the like.

Process 2 and subsequent processes are processes (a second process) for position correction. In Process 2, the reference mark 5 is measured, and the mark coordinates (a second position measurement value) 5b representing a position of the reference mark 5 is calculated after Process 1. The actual position of the reference mark 5 in Process 2 is the same as that in Process 1, but there is a possibility that a position measurement result of the reference mark 5 is shifted from the actual position due to a measurement error. Process 2 can be performed at a certain time or at a predetermined period after Process 1. In this regard, it is effective to perform Process 2 and the subsequent processes in a case where a measurement error is generated by a posture change in the main component in the three-dimensional position measurement apparatus 100 due to a change in the usage environment such as the temperature. Therefore, Process 2 may be performed in a case where it is detected that the usage environment such as the temperature is changed from when Process 1 is performed, and a condition such as a predetermined temperature difference is satisfied. The mark coordinates is not largely varied from the mark reference coordinates as a time interval between Process 1 and Process 2 is small, and a variation in a correction value to be calculated in the subsequent processes is small, so that correction accuracy can be improved.

In Process 3 (the second process), the inspection target object 4 is measured, and the workpiece coordinates (an object position) 4b is calculated. The workpiece coordinates 4b may be coordinates of a plurality of measurement points on the inspection target object 4 and coordinates of a representative position of the inspection target object 4. A timing of Process 3 may be the same as or different from that of Process 2. As an interval between the measurement of the reference mark 5 in Process 2 and the measurement of the inspection target object 4 in Process 3 is smaller, a difference in a measurement condition can be reduced, and deterioration in an accuracy of the correction amount to be calculated in the subsequent processes can be reduced.

In Process 4, a variation ΔZ_{b}n which is an error in the Z-axis direction of the reference mark 5 is calculated from the mark coordinates and the mark reference coordinates. The variation ΔZ_{b}n in the Z-axis direction is expressed by the following Equation 2:

ΔZ_{b}n=Z_{b}n−Z_{b}0 (Equation 2),
where Z_{b}n is a position in the Z-axis direction of the mark coordinates, and Z_{b}0 is a position in the Z-axis direction of the mark reference coordinates.

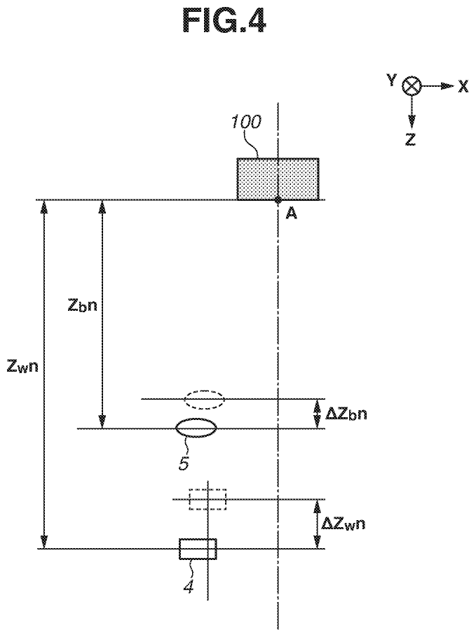

In Process 5, a correction value ΔZ_{w}n with respect to the position of the inspection target object 4 in the Z-axis direction is calculated. The correction value ΔZ_{w}n can be calculated using the following Equation 3, based on a relationship between the position in the Z-axis direction and the error in the above-described Equation 1. FIG. 4 illustrates a relationship in Equation 3. Where, Z_{w}n is a position in the Z-axis direction in the workpiece coordinates of the inspection target object 4 obtained in Process 3.

ΔZ_{w}n=ΔZ_{b}n*(Z_{w}n/Z_{b}n)\hat{ }2 (Equation 3)

The correction value ΔZ_{w}n can be calculated using the variation ΔZ_{b}n in the Z-axis direction of the reference mark 5 obtained in Process 4, a position Z_{w}n in the Z-axis direction in the workpiece coordinates of the inspection target object 4 obtained in Process 3, and a position Z_{b}n in the Z-axis direction in mark coordinates obtained in Process 2. A size of the correction value AZ_{w}n is different according to the position Z_{w}n in the Z-axis direction in the workpiece coordinates of the inspection target object 4, namely a position of the measurement point on the inspection target object 4.

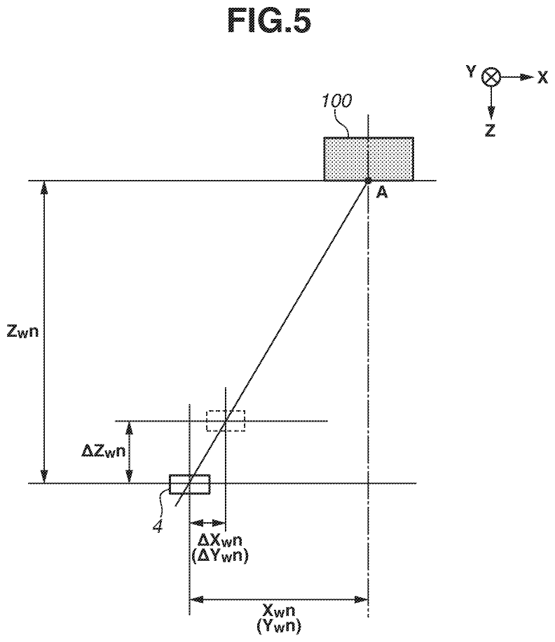

In Process 6, correction values ΔX_{w}n and ΔY_{w}n of positions in an X-axis direction and a Y-axis direction of the inspection target object 4 are calculated. Specifically, the correction values ΔX_{w}n and ΔY_{w}n in the X-axis direction and the Y-axis direction are calculated using Equations 4 and 5 from the correction value ΔZ_{w}n of the position in the Z direction of the inspection target object 4 calculated in Process 5 and the workpiece coordinates (X_{w}n, Y_{w}n, Z_{w}n) as the measurement value. FIG. 5 illustrates a relationship expressed by the following Equation 4 is illustrated in FIG. 5. The following Equation 5 expresses a relationship similar to that in Equation 4. Sizes of the correction values ΔX_{w}n and ΔY_{w}n varies (changed) according to the position Z_{w}n in the Z-axis direction in the workpiece coordinates of the inspection target object 4, namely the position of the measurement point on the inspection target object 4.

ΔX_{w}n=ΔZ_{w}n*(X_{w}n/Z_{w}n) (Equation 4)

ΔY_{w}n=ΔZ_{w}n*(Y_{w}n/Z_{w}n) (Equation 5)

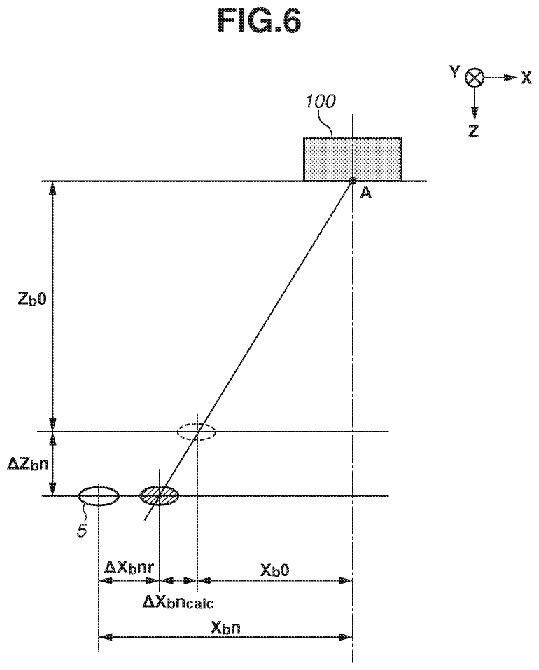

In Process 7, correction values in the X-axis direction and the Y-axis direction which do not vary according to (not depend on) the position of the inspection target object 4 are calculated from the mark coordinates and the mark reference coordinates. First, components (ΔX_{b}n__{calc}, ΔY_{b}n__{calc}) which vary according to the position of the reference mark and are predicted from the mark coordinates, the variation ΔZ_{b}n in the Z-axis direction in the mark reference coordinates, and the mark reference coordinates (X_{b}0, Y_{b}0, Z_{b}0) are calculated using the following Equations 6 and 7. FIG. 6 illustrates a relationship expressed by Equation 6.

ΔX_{b}n_{calC}=ΔZ_{b}n*(X_{b}0/Z_{b}0) (Equation 6)

ΔY_{b}n__{calc}=ΔZ_{b}n*(Y_{b}0/Z_{b}0) (Equation 7)
The components (ΔX_{b}n__{calc}, ΔY_{b}n__{calc}) are compared with the mark coordinates (X_{b}n, Y_{b}n) calculated from an actual measurement result, and differences therebetween are calculated using the following Equations 8 and 9 as correction values ΔX_{b}n_r and ΔY_{b}n_r in the X-axis direction and the Y-axis direction (also referred to as XY correction values) which do not vary according to the position.

ΔX_{b}n_r=(X_{b}n−X_{b}0)−ΔX_{b}n_{calc} (Equation 8)

ΔY_{b}n_r=(Y_{b}n−Y_{b}0)−ΔY_{b}n_{calc} (Equation 9)

In Process 8, the workpiece coordinates are corrected as expressed in the following Equations 10, 11, and 12 using the correction values obtained in Processes 5 to 7. In this regard, corrected workpiece coordinates are expressed as (X_{w}n__{correct}, Y_{w}n__{correct} Z_{w}n__{correct}) as corrected results.

X_{w}n__{correct}=X_{w}n−ΔX_{w}n−ΔX_{b}n_r (Equation 10)

Y_{w}n__{correct}=Y_{w}n−ΔY_{w}n−ΔY_{b}n_r (Equation 11)

Z_{w}n__{correct}=Z_{w}n−ΔZ_{w}n (Equation 12)

In the above description, the correction value (a measurement error) ΔZ_{w}n with respect to the position of the inspection target object 4 in the Z-axis direction is calculated using the square of a ration of coordinates Z_{b}n and Z_{w}n in the Z-axis direction of the inspection target object 4 and the reference mark 5. However, the correction value ΔZ_{w}n may be calculated using a multiplier from a power of 1.5 or more but not exceeding a power of 2.5 of a distance ratio in view of an error generated by other than a posture change in the main component and an accuracy improvement effect on the error.

The reason is as follows. For example, in a case where the three-dimensional position measurement apparatus 100 has a measurement range of 1500 to 2000 mm in the Z-axis direction, and a measurement error is 20 mm at a position of 1500 mm, if the square of an error of the z position is included, a measurement result will be 1520 to 2036 mm, and an error will be 36 mm at the maximum.

In this regard, in a case where the reference mark 5 is placed on the position of 1500 mm and measured, and the correction value at the Z position of 1500 mm is calculated using the square of a ratio of the Z position, the error becomes zero. In a case where the correction value is calculated using the Z position raised to the power of 1.5, the corrected measurement result will be 1500 to 2005 mm, and the error will be 5 mm at the maximum, so that the error can be relatively reduced. In addition, in a case where the reference mark 5 is placed on the position of 1500 mm and measured, and the correction value is calculated using a ratio of the Z position (distance) raised to the power of 2.5, the error can be reduced up to 5 mm. In other words, the error can be reduced about 30 percent or less in a range from the power of 1.5 to 2.5.

As described above, the three-dimensional position measurement apparatus 100 can accurately correct a measurement error at each position in the Z-axis direction using a simple reference object and reduce deterioration of measurement accuracy.

For example, in a case where another inspection target object 4 is sequentially measured after completion of Process 8, next measurement may be started from Process 3 without performing Processes 1 and 2. This is because, in a case where the temperature change is small from the immediately preceding measurement, the mark coordinates do not largely change, and variations in the correction values in Processes 5, 6, and 7 are small.

It is described above that the reference mark 5 is one, but two or more reference marks 5 may be used. In a case where two or more reference marks 5 are used, the mark reference coordinates and the mark coordinates are obtained for the respective reference marks 5 in Processes 1 and 2. Then, in Process 3, the variation ΔZ_{b}n may be calculated by averaging the mark reference coordinates and the mark coordinates of the respective reference marks 5.

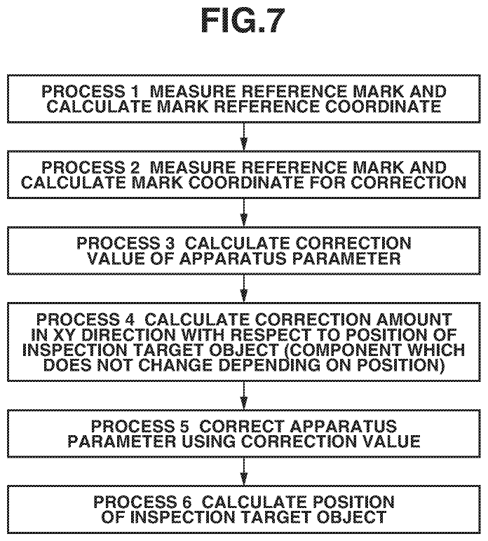

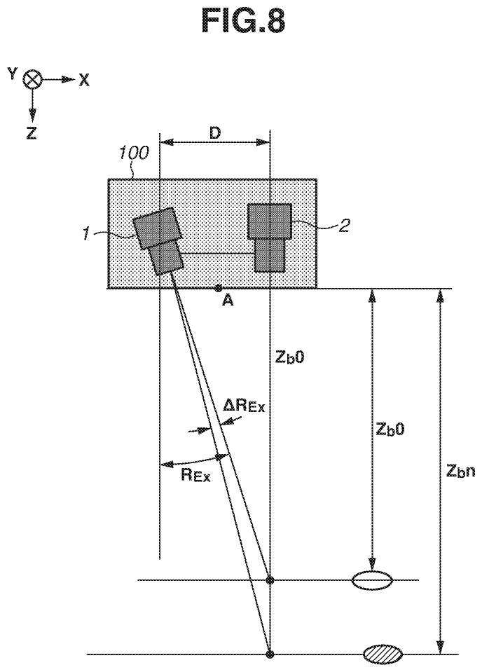

Next, the three-dimensional position measurement apparatus 100 according to a second example is described with reference to FIGS. 7 and 8. FIG. 7 is a flowchart illustrating measurement according to the second example. First, Processes 1 and 2 are executed, and the mark reference coordinates and the mark coordinates are obtained as with the first example.

In Process 3, a variation ΔR_{Ex} of a convergence angle R_{Ex} which is a relative angular difference between the optical axes of the projector 1 and the image capturing unit 2 is calculated as the correction value. The variation ΔR_{Ex} of the convergence angle R_{Ex} is one of the apparatus parameters to be used for calculating a position measurement result of the three-dimensional position measurement apparatus 100. FIG. 8 illustrates a variation of the convergence angle R_{Ex}. The variation ΔR_{Ex} of the convergence angle R_{Ex} can be calculated from a position Z_{b}0 in the Z-axis direction in the mark reference coordinates, the position Z_{b}n in the Z-axis direction in the mark coordinates, and a base length D between the projector 1 and the image capturing unit 2. The correction value of the convergence angle is described here. However, in a case of the apparatus parameter of which an error changes by the square of the ratio of the distance in the Z-axis direction from the three-dimensional position measurement apparatus 100, shifts (positional deviations) of the pattern generation unit in the projector 1 and the image pickup element of the image capturing unit 2 may be used as correction items.

In Process 4, the correction values ΔX_{b}n_r and ΔY_{b}n_r in the X-axis direction and the Y-axis direction which do not change depending on the position of the inspection target object 4 are calculated. A method for calculating the correction value is similar to that in Process 7 according to the first example, and the correction values can be calculated from the variations in the Z-axis direction in the mark coordinates and the mark reference coordinates and the mark reference coordinates as expressed in Equations 6 to 9. Alternatively, the mark coordinates of the reference mark 5 is recalculated using the apparatus parameter of the three-dimensional position measurement apparatus 100 which is corrected by the correction value obtained in Process 3, and the correction values ΔX_{b}n_r and ΔY_{b}n_r may be calculated from a difference between the recalculated mark coordinates of the reference mark 5 and the mark reference coordinates.

In Process 5, the apparatus parameter of the three-dimensional position measurement apparatus 100 is corrected using the correction values obtained in Processes 3 and 4. However, in Process 5, the apparatus parameter may not be corrected by the X and the Y correction values obtained in Process 4, and a calculated result in Process 6 may be corrected using the X and the Y correction values.

Finally, in Process 6, the inspection target object 4 is measured, and the position of the inspection target object 4 is calculated using the corrected apparatus parameter and obtained as the corrected workpiece coordinates.

As described above, the three-dimensional position measurement apparatus 100 can be calibrated using a simple reference object, and the three-dimensional position measurement apparatus which reduces deterioration of the measurement accuracy can be realized.

In a case where another inspection target object 4 is sequentially measured, processing may be started from Process 4 after completion of Process 6. This is because, in a case where the temperature change is small from the immediately preceding measurement, the mark coordinates do not largely change, and variations in the correction values in Process 4 are small. For example, a temperature difference from the immediately preceding measurement is checked, a condition such as a certain temperature difference is set, and the processing may be started from Process 4 in a case where the condition is satisfied.

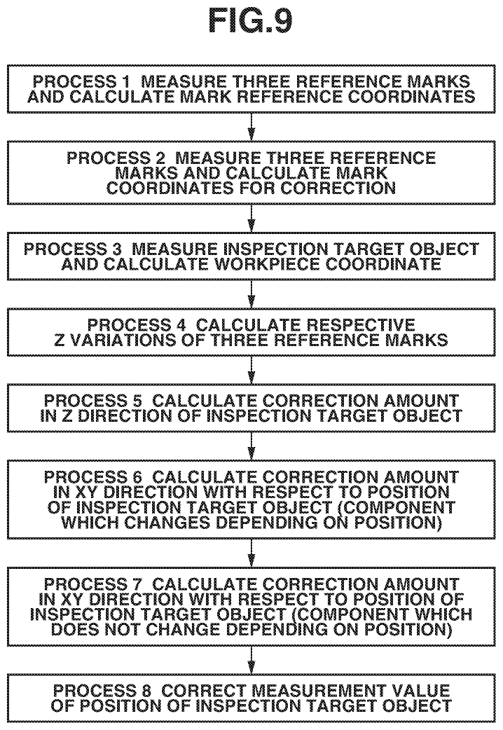

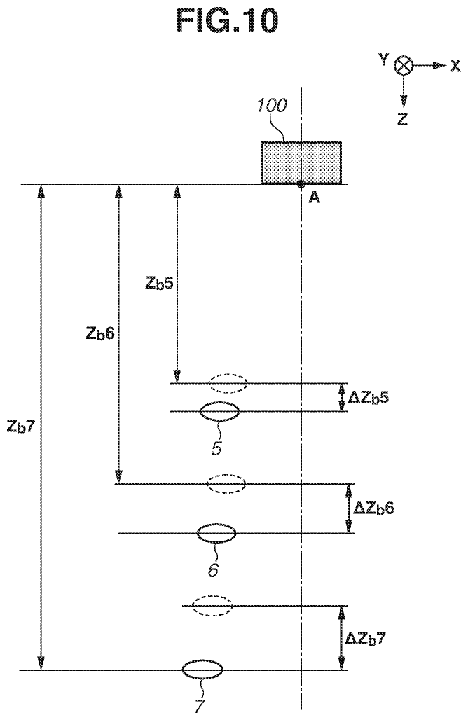

Next, the three-dimensional position measurement apparatus 100 according to a third example is described with reference to FIGS. 9 and 10. FIG. 9 is a flowchart illustrating a measurement method according to the third example. The present example is different from the first example in that three reference marks 5, 6, and 7 are arranged on positions different from each other in the Z-axis direction as illustrated in FIG. 10. Therefore, the present example is different from Process 4 in the flowchart in FIG. 3 according to the first example in that a variation is calculated for each reference mark. Further, the present example is different in a method for calculating a correction amount in the Z-axis direction in Process 5.

In advance in Process 1, the reference marks 5, 6, and 7 are measured in a state in which the relative position between the inspection target object 4 and the reference mark 5 is correctly measured, and the respective mark reference coordinates are obtained as coordinate information about correction references.

Generally, Process 1 is performed again in a case where the mark reference coordinates are deviated from those obtained in Process 1 performed in advance, such as a case in which the reference marks 5, 6, and 7 are actually deviated from the arranged positions.

Process 2 and the subsequent processes are performed in a case where an actual inspection target object 4 is measured. In Process 2, the reference marks 5, 6, and 7 are measured for calculating correction amounts. In this procedure, the mark coordinates are obtained for the respective reference marks as with Process 1.

In Process 3, the inspection target object 4 is measured, and the workpiece coordinates are obtained as with Process 3 according to the first example. In a case where another inspection target object 4 is sequentially measured, processing may be started from Process 3 after completion of Process 8. This is because, in a case where the temperature change is small from the immediately preceding measurement, the mark coordinates do not largely change, and variations in the correction values are small. For example, a temperature difference from the immediately preceding measurement is checked, a condition such as a certain temperature difference is set, and the processing may be started from Process 3 in a case where the condition is satisfied.

In Process 4, reference coordinates of the respective reference marks 5, 6, and 7 and variations ΔZ_{b}5, ΔZ_{b}6, and ΔZ_{b}7 in the Z-axis direction in the respective reference coordinates are calculated.

Next, in Process 5, the correction value ΔZ_{w}n in the Z-axis direction of the inspection target object 4 is calculated. If errors ΔZ_{b}5, ΔZ_{b}6, and ΔZ_{b}7 in the Z-axis direction of the reference marks 5, 6, and 7 from the three-dimensional position measurement apparatus 100 are regarded as coordinates Z_{b}5, Z_{b}6, and Z_{b}7 in the Z-axis direction of the respective reference marks 5, 6, and 7 from the three-dimensional position measurement apparatus 100, the coordinates Z_{b}5, Z_{b}6, and Z_{b}7 can be expressed by the following Equations 13, 14, and 15,

A+B+C=ΔZ_{b}5 (Equation 13),

A*(Z_{b}6/Z_{b}5)\hat{ }2+B*(Z_{b}6/Z_{b}5)+C=ΔZ_{b}6 (Equation 14), and

A*(Z_{b}7/Z_{b}5)\hat{ }2+B*(Z_{b}7/Z_{b}5)+C=ΔZ_{b}7 (Equation 15).

A, B, and C represent the error values of the reference mark 5, more specifically, the error component A changes by the square of the ratio of the distance in the Z-axis direction, the error component B changes by the ratio of the distance in the Z-axis direction, and the error component C uniformly changes regardless of the Z-axis direction.

The error values A, B, and C of the reference mark 5 are calculated from Equations 13, 14, and 15, and error components Z_{w}n_{A} which changes by the square of the ratio of the distance of the object to be inspected 4 and an error component Z_{w}n_{B} which changes by the distance ratio are calculated from the workpiece coordinates of the inspection target object 4 by the following Equations 16 and 17:

ΔZ_{w}n_{A}=A*(Z_{w}n/Z_{b}5)\hat{ }2 (Equation 16), and

ΔZ_{w}n_{B}=B*(Z_{w}n/Z_{b}5) (Equation 17).

Regarding the error component C which uniformly changes, external factors such as a positional change of the entire three-dimensional position measurement apparatus 100 and a change in a position on which the reference mark 5 is arranged can be considered. Therefore, in a case where the error component C has an effect on the error more than the error caused by the error components A and B, it is desirable to perform measurement again, for example, by performing calibration of the position and the posture of the three-dimensional position measurement apparatus 100 in a state in which a relative position between the coordinates of the inspection target object and the coordinates of the reference object is correctly measured.

In Process 6, an error component which changes depending on the position of the inspection target object 4 is calculated from the correction values ΔZ_{w}n_{A} and ΔZ_{w}n_{B} in the Z direction calculated in Process 5 and the workpiece coordinates (X_{w}n, Y_{w}n, Z_{w}n), and the correction values ΔX_{w}n and ΔY_{w}n are calculated by the following Equations 18 and 19:

ΔX_{w}n=(ΔZ_{w}n_{A}+ΔZ_{w}n_{B})*(X_{w}n/Z_{w}n) (Equation 18), and

ΔY_{w}n=(ΔZ_{w}n_{A}+ΔZ_{w}n_{B})*(Y_{w}n/Z_{w}n) (Equation 19).

In Process 7, the XY correction values which do not change depending on the position of the inspection target object 4 are calculated for the respective reference marks 5, 6, and 7. In Process 7, XY error components which change depending on the positions of the reference marks 5, 6, and 7 are calculated as with Process 6 using the error components A and B obtained in Process 5. The XY error components which do not change depending on the positions are calculated for each of the reference marks 5, 6, and 7 from the XY error components which change depending on the positions and variations of the mark coordinates and the mark reference coordinates as with Process 7 according to the first example, and the correction values ΔX_{b}n_r and ΔY_{b}n_r are calculated by averaging the XY error components which do not change depending on the positions.

In Process 8, the workpiece coordinates are corrected using the correction values obtained in Processes 5, 6, and 7, and the corrected workpiece coordinates (X_{w}n__{correct}, Y_{w}n__{correct}, Z_{w}n__{correct}) are calculated by the following Equations 20, 21, and 22:

X_{w}n__{correct}=X_{w}n−ΔX_{w}n−ΔX_{b}n_r (Equation 20),

Y_{w}n__{correct}=Y_{w}n−ΔY_{w}n−ΔY_{b}n_r (Equation 21), and

Z_{w}n__{correct}=Z_{w}n−(ΔZ_{w}n_{A}+ΔZ_{w}n_{B}) (Equation 22).

Accordingly, the three-dimensional position measurement apparatus 100 can separate a correction component which changes by each position using a smaller number of the reference marks and calculate a correction amount of each separated correction component. The three-dimensional position measurement apparatus which reduces deterioration of the measurement accuracy further than the first example and the second example can be therefore realized.

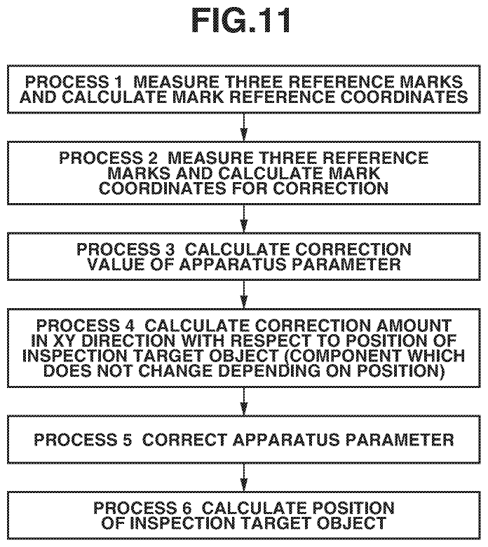

Next, the three-dimensional position measurement apparatus 100 according to a fourth example is described with reference to FIG. 11. FIG. 11 is a flowchart illustrating a measurement method according to the fourth example. Processes 1 and 2 are performed similarly to those according to the third example, and the mark reference coordinates and the respective mark coordinates are respectively obtained.

In advance in Process 1, the reference marks 5, 6, and 7 are measured in a state in which the relative position between the inspection target object 4 and the reference mark 5 is correctly measured (for example, after the calibration), and the respective mark reference coordinates are obtained as the coordinate information about the correction reference. Generally, Process 1 is performed again in a case where the mark reference coordinates are deviated from the original one obtained in Process 1 performed in advance, such as a case in which the reference marks 5, 6, and 7 are actually deviated from the arranged positions.

Process 2 and the subsequent processes are performed in a case where an actual inspection target object 4 is measured. In Process 2, the reference marks 5, 6, and 7 are measured for calculating correction amounts. In this process, the mark coordinates are obtained for the respective reference marks as with Process 1.

In Process 3, the correction values of the apparatus parameter to be used for calculation of position measurement by the three-dimensional position measurement apparatus 100 are calculated from the respective mark reference coordinates and the respective reference coordinates. As with the third example, the error values of the reference mark 5, namely the error component A which changes by the square of the ratio of the distance in the Z-axis direction, the error component B which changes by the ratio of the distance in the Z-axis direction, and the error component C which uniformly changes regardless of the Z-axis direction are calculated. Next, the correction amounts are respectively calculated from the error component A and the error component B as the apparatus parameter. The error component A changes in proportion to the square of the ratio of the distance, and the correction values are calculated as the variation of the convergence angle between the projector 1 and the image capturing unit 2 and shift components of the pattern generation unit in the projector 1 and the image pickup element of the image capturing unit 2 as with the second example. Next, the correction value of the base length between the projector 1 and the image capturing unit 2 is calculated from the error component B which is proportional to the ratio of the distance. Regarding the error component C which uniformly changes, external factors such as the positional change of the entire three-dimensional position measurement apparatus 100 and the change in the position on which the reference mark 5 is arranged can be considered. Therefore, in a case where the error component C has an effect on the error more than the error caused by the error components A and B, it is desirable to perform measurement again, for example, by performing calibration of the position and the posture of the three-dimensional position measurement apparatus 100 in a state in which the relative position between the coordinates of the object to be inspected and the coordinates of the reference object is correctly measured.

In Process 4, the XY correction values ΔX_{b}n_r and ΔY_{b}n_r which do not change depending on the position of the inspection target object 4 are calculated. A method for calculating the correction value is similar to that in Process 7 according to the third example, and the correction values can be calculated from the variations in the Z-axis direction in the respective mark coordinates and the respective mark reference coordinates and the mark reference coordinates. Alternatively, the coordinates of the reference marks 5, 6, and 7 are recalculated using the apparatus parameter of the three-dimensional position measurement apparatus 100 which is corrected by the correction value obtained in Process 3, and the correction values ΔX_{b}n_r and ΔY_{b}n_r may be calculated by averaging respective differences between the recalculated coordinates of the reference marks 5, 6, and 7 and the mark reference coordinates.

In Process 5, the apparatus parameter of the three-dimensional position measurement apparatus 100 is corrected using the correction values obtained in Processes 3 and 4. In a case where the XY correction values obtained in Process 4 are not used as the apparatus parameter, in Process 6, the calculated results are corrected by the correction values in Process 4.

Finally, in Process 6, the inspection target object 4 is measured, and the corrected workpiece coordinates (X_{w}n__{correct}, Y_{w}n__{correct}, Z_{w}n__{correct}) are obtained by performing calculation using the apparatus parameter corrected in Process 5.

Accordingly, the three-dimensional position measurement apparatus 100 can separate a correction component which changes by each position using a smaller number of the reference marks and calculate a correction amount of each separated correction component. The three-dimensional position measurement apparatus which reduces deterioration of the measurement accuracy further than the first example and the second example can therefore be realized.

While, according to the present exemplary embodiment, the projector projects a pattern, and a single image capturing unit (a first optical system) captures an image, the present exemplary embodiment can also be applied to a configuration in which a plurality of image capturing units (the first optical systems) is arranged in different directions with respect to a projector (a second optical system) which illuminates an object with light. In this case, correction is performed for each combination of the projector and the respective image capturing units, and measurement results may be combined. While, according to the present exemplary embodiment, the three-dimensional position measurement apparatus adopting the pattern projection method is described, the present exemplary embodiment can be applied to a three-dimensional position measurement apparatus adopting a stereo method using the principle of triangulation based on an image captured by two image capturing units (the first optical system and the second optical system) of which relative position and posture are known. While, according to the present exemplary embodiment, correction is performed based on the (X, Y, Z) coordinate system, correction may be performed based on the origin A and rotation.

Next, a second exemplary embodiment is described. According to the second exemplary embodiment, an actual position of a reference mark 5 for calculating mark reference coordinates (a first position measurement value) and an actual position of the reference mark 5 for calculating mark coordinates (a second position measurement value) are different. According to the first exemplary embodiment, the actual position of the reference mark 5 for calculating the mark reference coordinates is set to the same position as the actual position of the reference mark 5 for calculating the mark coordinates. Therefore, according to the second exemplary embodiment, it is necessary to perform correction including a difference between these positions unlike the first exemplary embodiment.

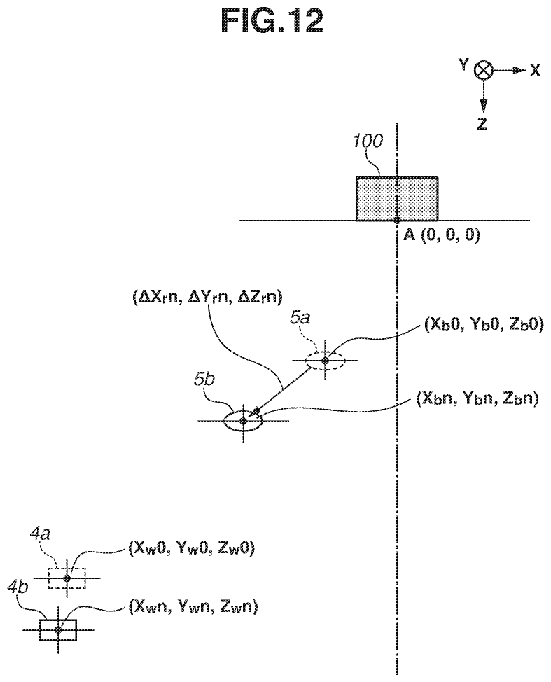

FIG. 12 illustrates measurement and correction according to the present exemplary embodiment. According to the present exemplary embodiment, in Process 1, the reference mark 5 (a reference member) is mounted on a robot, moved to and arranged on a predetermined position by the robot, and measured. Mark reference coordinates 5a measured at this process are denoted as (X_{b}0, Y_{b}0, Z_{b}0). Then, in Process 2, the robot moves and arranges the reference mark 5 so that an actual position of the reference mark 5 is different from the actual position of the reference mark 5 in Process 1. The reference mark 5 is measured, and mark coordinates (X_{b}n, Y_{b}n, Z_{b}n) are calculated. In Processes 1 and 2, if position control of the robot is highly accurately performed, there is very little arrangement error, and differences (ΔXᵣn, ΔYᵣn, ΔZᵣn) in the actual positions of the reference marks 5 in Processes 1 and 2 can be calculated from control information about the robot.

Therefore, coordinate information equivalent to a result measuring the mark reference coordinates 5a at the same position as a measurement position of the mark coordinates 5b can be obtained from a result obtained by offsetting the difference between the above-described actual measurement positions at the time of measuring the mark reference coordinates 5a and the mark coordinates 5b with respect to the mark reference coordinates 5a. For example, a measurement error (a variation) ΔZ_{b}n in the Z direction included in the measurement result of the mark coordinates 5b is expressed by the following Equation 23:

ΔZ_{b}n=Z_{b}n−Z_{b}0−ΔZᵣn (Equation 23).

Measurement errors in the X direction and the Y direction can be calculated using a similar equation.

Therefore, even in a case where positions of the mark reference coordinates and the mark coordinates are different, correction can be performed similarly to the first exemplary embodiment in view of a difference of the positions using a change in arrangement of the reference mark 5 such as position coordinates (mark position control information) of the robot. The positions of the mark reference coordinates and the mark coordinates are different, and thus a restriction on a setting range of the inspection target object 4 can be reduced than the first exemplary embodiment.

As described above, the three-dimensional position measurement apparatus 100 can perform correction without fixing a position of the reference mark 5, and thus the three-dimensional position measurement apparatus can be realized which reduces the restriction on the setting range of the inspection target object more than the first exemplary embodiment.

### (System)

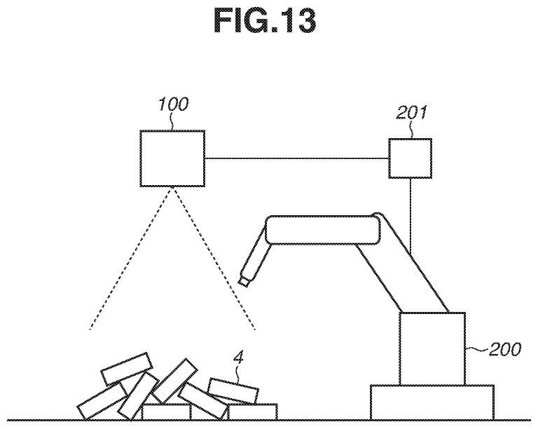

The three-dimensional position measurement apparatus 100 can calculate a distance, a shape, and a posture of the inspection target object 4 using a corrected position (distance information) of the inspection target object 4. The three-dimensional position measurement apparatus 100 is used as, for example, a system combined with a robot 200. FIG. 13 illustrates the system. The three-dimensional position measurement apparatus 100 outputs the calculated position and posture of the inspection target object 4 to a robot control unit 201, and the robot control unit 201 controls the robot 200 to grip and move the inspection target object 4 with a gripping unit such as a hand of the robot 200 based on the output position and posture. Further, one of a plurality of the inspection target objects 4 stacked in a pile is moved by the hand of the robot 200, and then the three-dimensional position measurement apparatus 100 repeats measurement of the plurality of the inspection target object 4 stacked in a pile.

### (Article Manufacturing Method)

A manufacturing method is described below for manufacturing an article, such as a machine component, using the above-described three-dimensional position measurement apparatus. First, the above-described three-dimensional position measurement apparatus measures a position and a posture of an object in a plurality of objects such as machine components stacked in a pile. Then, the robot control unit 201 controls the robot 200 to grip and move the object with the gripping unit such as the hand of the robot 200 based on the position and the posture of the object. The moved object is subjected to processing for being connected, fastened, and inserted to another component. The object is further subjected to processing in another working process. Accordingly, an article including the processed object is manufactured.

While the present invention has been described above with reference to exemplary embodiments, it is to be understood that the present invention is not limited to the disclosed exemplary embodiments. The scope of the following claims is to be accorded the broadest interpretation so as to encompass all modifications, equivalent structures, and functions.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2019-034286, filed Feb. 27, 2019, and No. 2019-173518, filed Sep. 24, 2019, which are hereby incorporated by reference herein in their entirety.

What is claimed is:

1. A method for calculating a position of an object, comprising:
a first process to calculate a first position measurement value of a reference member in a depth direction of a measurement range of a three-dimensional measurement apparatus using a measurement result of the reference member measured by the three-dimensional measurement apparatus; and
a second process to calculate a second position measurement value of the reference member and a position of the object in the depth direction using measurement results of the reference member and the object measured by the three-dimensional measurement apparatus,
wherein, in the second process, the position of the object is calculated by correcting an error difference which varies according to the position of the object in the depth direction, using the first position measurement value and the second position measurement value of the reference member.

2. The method according to claim 1, wherein the position of the object is calculated by correcting an error difference which is proportional to a multiplier from 1.5th to 2.5th power of a distance to the object in the depth direction.

3. The method according to claim 1, wherein the second process further
calculates a first position of the object in the depth direction using a measurement result of the object measured by the three-dimensional measurement apparatus;
calculates a first correction value with respect to the first position of the object; and
corrects the first position of the object using the first correction value and calculating a second position after correction as the position of the object,
wherein the first correction value includes a correction value difference which varies according to the position of the object in the depth direction.

4. The method according to claim 3, wherein the first correction value is calculated using the first position measurement value and the second position measurement value of the reference member and the first position of the object.

5. The method according to claim 3, wherein the first correction value includes a correction value which is proportional to a multiplier from the 1.5th to 2.5th power of a distance to the object in the depth direction.

6. The method according to claim 3, wherein the first correction value includes a correction value which is proportional to the square of a distance to the object in the depth direction and a correction value which is proportional to the distance to the object in the depth direction.

7. The method according to claim 1, wherein the second process further:
calculates a correction value with respect to a parameter of the three-dimensional measurement apparatus using the first position measurement value and the second position measurement value of the reference member; and
corrects the parameter using the correction value with respect to the parameter and calculating the position of the object in the depth direction using the parameter after correction and a measurement result of the object,
wherein, the parameter changes the position of the object in the depth direction in a degree which varies according to the position of the object in the depth direction in a case where a value of the parameter changes.

8. The method according to claim 7, wherein the parameter includes a first parameter which changes the position of the object in the depth direction in a degree which is proportional to a multiplier from the 1.5th to 2.5th power of a distance to the object in the depth direction in a case where a value of the first parameter changes.

9. The method according to claim 7,
wherein the three-dimensional measurement apparatus performs measurement using a first optical system configured to receive light from the object and a second optical system configured to receive light from the object or to illuminate the object with light, and
wherein the parameter is a convergence angle or a base length between the first optical system and the second optical system.

10. The method according to claim 7,
wherein the three-dimensional measurement apparatus performs measurement using an image pickup element which receives light from the object, and
wherein the parameter is a position of the image pickup element.

11. The method according to claim 7,
wherein the three-dimensional measurement apparatus performs measurement using a projection optical system configured to project light onto the object,
wherein the projection optical system includes a generation unit configured to generate pattern light to project, and
wherein the parameter is a position of the generation unit.

12. The method according to claim 7, wherein the parameter includes a first parameter which changes the position of the object in the depth direction in a degree which is proportional to the square of a distance to the object in the depth direction in a case where a value of the first parameter changes and a second parameter which changes the position of the object in the depth direction in a degree which is proportional to the distance to the object in the depth direction in a case where a value of the second parameter changes.

13. The method according to claim 2, wherein the multiplier is the square.

14. The method according to claim 1, wherein the second process further:
calculates a third position of the object in a perpendicular direction perpendicular to the depth direction, using a measurement result of the object measured by the three-dimensional measurement apparatus;
calculates a second correction value with respect to a position of the object in the perpendicular direction; and
corrects the third position of the object using the second correction value,
wherein the second correction value includes a correction value which varies according to the position of the object in the depth direction.

15. The method according to claim 14, wherein the second correction value includes a correction value independent of the position of the object in the depth direction.

16. The method according to claim 1, wherein the reference member includes three marks or less.

17. The method according to claim 16, wherein the reference member includes three marks.

18. A method for manufacturing an article, the method comprising:
calculating a position of an object using the method according to claim 1; and
manufacturing the article by performing processing on the object based on the calculated position.

19. A non-transitory recording medium recording a program for causing a computer to execute a method for calculating a position of an object, the method comprising:
a first process to calculate a first position measurement value of a reference member in a depth direction of a measurement range of a three-dimensional measurement apparatus using a measurement result of the reference member measured by the three-dimensional measurement apparatus; and
a second process to calculate a second position measurement value of the reference member and a position of the object in the depth direction using measurement results of the reference member and the object measured by the three-dimensional measurement apparatus,
wherein, in the second process, the position of the object is calculated by correcting an error difference which varies according to the position of the object in the depth direction, using the first position measurement value and the second position measurement value of the reference member.

20. An information processing apparatus which calculates a position of an object, the information processing apparatus comprising:
a processing unit configured to calculate a first position measurement value of a reference member in a depth direction in a measurement range of a three-dimensional measurement apparatus, using a measurement result of the reference member measured by the three-dimensional measurement apparatus, and to calculate a second position measurement value of the reference member and a position of the object in the depth direction using measurement results of the reference member and the object measured by the three-dimensional measurement apparatus,
wherein the processing unit calculates the position of the object by correcting an error difference which varies according to a position of the object in the depth direction, using the first position measurement value and the second position measurement value of the reference member.

21. A system comprising:
a three-dimensional measurement unit configured to measure an object; and
the information processing apparatus according to claim 20 which performs arithmetic processing on data measured by the three-dimensional measurement unit and calculates a position of the object.

22. The system according to claim 21, further comprising a robot configured to move the object.
